(19) United States
(12) Patent Application Publication
(10) Pub. No.: US 2005/0184967 A1
(43) Pub. Date: Aug. 25, 2005

(54) Sensory drawing apparatus

(76) Inventors: Shunsuke Yoshida, Kyoto (JP); Jun Kurumisawa, Kyoto (JP); Haruo Noma, Kyoto (JP); Nobuji Tetsutani, Kyoto (JP)

Correspondence Address: Gerald T. Bodner, Esq.;BODNER & O'ROURKE, LLP, Suite 108, 425 Broadhollow Road, Melville, NY, 11747, US

(21) Appl. No.: 10/898,054

(22) Filed: Jul. 23, 2004

(30) Foreign Application Priority Data
Feb. 23, 2004 (JP) 2004-46807

(51) Int. Cl. G09G 5/00

(52) U.S. Cl. 345/173

(57) ABSTRACT

A sensory drawing apparatus includes a desk plate, and on the desk plate, an image is displayed by a computer. The image is an image drawn by a user, and displayed in a flowing manner, which means an image is flowed or floated on the desk plate like running water. When the user uses a pointing device so as to draw the image, at least one force, out of inertia by a weight of color defined according to the color, a fluid resistance by a flow of the image, and a color friction resistance in a color border of the displayed image, is added. The computer generates a driving voltage for adding these forces, and applies to an inverter of a linear motor via a peripheral device-use signal processing apparatus. Therefore, a translation force is acted on a conductive material, and the force is presented to the user who holds the pointing device.

### BACKGROUND OF THE INVENTION

1. Field of the Invention

The present invention relates to a sensory drawing apparatus. More specifically, the present invention relates to a sensory drawing apparatus that uses a digital disk used as a computer interface.

2. Description of the Prior Art

One example of a prior art approximate to this kind of a sensory drawing apparatus is disclosed in “Computer Augmented Environments: Back to the Real World”, ACM Press. In a digital desk of this prior art, an executing screen of Excel™ operated on an operating system as a Windows™ is developed on a desk by a projector, for example, and as a result of a hand and finger, or a pen directly pointing on the desk, this pointing is recognized by a captured image from a camera, and an inputting location on this screen is specified. In addition, by pointing by a finger tip a letter or a numeral written on a paper placed on the desk, the letter or the numeral, and etc., are recognized by the captured image from the same camera, and detected as a specified inputting location. That is, the prior art was used as a computer interface capable of easily inputting, without using a keyboard or a computer mouse.

In addition, another example of the prior art is disclosed in “The Actuated Workbench: Computer-Controlled Actuation in Tabletop Tangible Interface” published in the Proceedings of UIST 2002, Oct. 27-30, 2002, copyright 2002 ACM. The digital desk of this prior art is a desk having stepping motors bedded thereunder, controlling a location of a magnetic material on the desk, and acting to a real world.

In the former, it is possible to operate without using an inputting apparatus such as the keyboard and the computer mouse so that it is possible to make an operation easy. However, it is not possible to act from the computer to the real world.

On the other hand, in the latter, it is possible to act to the real world from the computer. However, this is only to move the magnetic material on the desk, and is not sufficient as the interface of a computer that handles various pieces of information such as image information, and etc.

### SUMMARY OF THE INVENTION

Therefore, it is a primary object of the present invention to provide a novel sensory drawing apparatus capable of experiencing a sensory feeling of an image by a sense of touch.

A sensory drawing apparatus according to the present invention comprises a displaying means for displaying at least an image, a pointing means for inputting at least operation information by a user so as to draw, and a force presenting means for applying a force at least corresponding to a color of a drawn image to the pointing means when drawn by the pointing means.

More specifically, on the displaying means of the sensory drawing apparatus, at least an image is displayed. The pointing means is used for inputting at least operation information by a user so as to draw the image. The force presenting means applies a force at least corresponding to a color of a drawn image to the pointing means when the user draws by using the pointing means. The force presenting means applies a force corresponding to a color in line that is drawn, for example. Thereby, the force is presented to a hand or a finger of the user that operates the pointing device, for example.

According to the present invention, it is possible to present the force corresponding to the color of the image so that it is not only possible to obtain a feeling as if to draw a picture on a canvas in reality but also obtain a virtual touch of the image obtainable from a weight defined to the color, which enables to realize a computer interface even more easy to use.

In a certain aspect of the present invention, a sensory drawing apparatus further comprises a color determining means for determining at least the color, and includes a color attaching means for attaching the color determined by the color determining means into a current location instructed by the pointing means when drawn by the pointing means. More specifically, the color determining means determines at least the color regarding a point or a line that is drawn. The color attaching means attaches the determined color into a current location instructed by the pointing means when drawn by the pointing means. Thus, a desired color is determined, and it is possible to draw the point and the line by the determined color. In addition, it is possible to present a force corresponding to the determined color so that it is possible to feel the weight of color.

In another aspect of the present invention, the displaying means includes a mixing means for applying a predetermined transparency, and mixing the color displayed in a location currently instructed by the pointing means to the color attached in the location instructed by the pointing means at a time of starting an operation when drawn by the pointing means. More specifically, the mixing means applies a predetermined transparency, and mixes the color displayed in a location currently instructed by the pointing means to the color in the location instructed by the pointing means at a time of starting an operation when drawn by the pointing means. That is, it is possible to mix the colors already drawn to each other, and its situation is displayed. Thus, the colors already painted are mixed to each other so that it is possible to draw as a result of the mixing, and in addition, to present a force corresponding to a mixed color.

In another aspect of the present invention, the image is displayed in a flowing manner to an arbitrary direction, which actually means “ink-floating” as if the ink dropped on the water surface floats or flows by running water. More specifically, the displaying means arbitrarily displays the image in a flowing manner. This flow changes the image, for example. Thus, the image is displayed in a flowing manner, and the image is changed by the flow so that the color is not only painted, nor mixed, but it is possible to enjoy the change of the image by the flow.

In a certain embodiment of the present invention, a sensory drawing apparatus further comprises a flow determining means for determining at least the direction to which the image flows. The displaying means displays the image in a flowing manner to the direction determined by the flow determining means. More specifically, the flow determining means determines at least the direction to which the image flows. The displaying means displays the image in a flowing manner to the direction determined by the flow determining means. Thus, it is possible to determine the direction to which the image flows so that the change of the image by the flow does not become monotone, thus possible to increase a joy of drawing.

In another embodiment of the present invention, the flow determining means further determines a force of flow of the image. Thus, it is also possible to change the intensity of the flow of the image so that it is possible to prevent the change of the image by the flow from becoming monotone.

In another aspect of the present invention, the force presenting means applies to the pointing means a force based on at least one of inertia force by a weight of color corresponding to an attached color, a force of flow resistance by a flow of the image, and a force of color change resistance in a color border regarding an image already drawn. More specifically, the weight of color corresponding to the color is defined in advance, for example. The force presenting means applies to the pointing means a force based on at least one of the inertia force by a weight of color corresponding to an attached color, the force of flow resistance by a flow of the image, and the force of color change resistance in a color border regarding an image already drawn. Thereby, the user is capable of experiencing by the force the weight of color to be drawn, the flow of the image, and the change of color of the drawn image. Thus, it is possible to experience by the force the weight of color to be drawn, the flow of the image, and the change of color of the drawn image so that it is not only possible to obtain a sense of immersion as if to draw a picture on an actual canvas, but also to draw by enjoying a virtual touch of a drawing material (image) obtainable from the weight defined to the color, and a sensation resulted from phenomenon by the flow of the image that resembles the flow of water.

In a certain embodiment of the present invention, the weight of color is determined according to any one or more than one of luminance, brightness, hue and saturation of color, or a combination thereof More specifically, the weight of color is determined at least according to the luminance of color. In a case that the luminance is high, the weight of color is rendered light, and in a case that the luminance is low, the weight of color is rendered heavy, for example. Thus, the weight of color is determined according to the luminance of color, and thereby, it is possible to feel the force by the weight of color so that it is not only possible to enjoy the color of the image by a visual sense, but also enjoy the color of the image by the touch.

In another aspect of the present invention, the displaying means includes at least a desk plate and a projector, the pointing means includes a holding portion to be held by a user and an operation information detecting means that detects the operation information, and the force presenting means includes a linear induction motor provided with a conductivity material joined to the holding portion and provided on the desk plate, a stator core provided under the desk plate, and a stator coil wound around the stator core. More specifically, the displaying means includes at least a desk plate and a projector. A drawn picture is displayed on the desk plate by the projector, for example. The pointing means includes a holding portion to be held by a user and an operation information detecting means that detects the operation information. That is, the user holds the pointing means and draws the image. The operation information is detected by the operation information detecting means. The force presenting means includes a linear induction motor. The conductivity material, which is the stator or unrolled rotor of the linear induction motor, is mounted on the desk plate, and joined to the holding portion. In addition, a stator core, and a stator coil of the linear induction motor are provided under the desk plate. That is, by the stator core and the stator coil, traveling magnetic force corresponding to the size and the direction of the force is occurred, and thereby, a translation is acted on the conductor material. Thus, the holding portion joined to the conductor material is moved, and therefore, the force is presented to the user. Thus, by using the force presenting means such as the linear induction motor, it is possible to present the force the user.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one example of structure of a sensory drawing apparatus of the present invention;

FIG. 2 is an illustrative view showing one example of structure of a desktop apparatus shown in FIG. 1;

FIG. 3 is an illustrative view showing electrical structure of a coil wound around a stator core of a linear motor shown in FIG. 2;

FIG. 4 is an illustrative view showing electrical structure of a pointing device shown in FIG. 1, and an illustrative view showing a pattern of an infrared LED blinked when a button provided thereon is turned on/off;

FIG. 5 is an illustrative view showing specific structure of a projector unit shown in FIG. 1;

FIG. 6 is an illustrative view showing specific structure of a detection apparatus shown in FIG. 1, and an illustrative view for describing a method for which an infrared light is detected by a detecting element provided thereon;

FIG. 7 is an illustrative view showing an example of a computer screen displayed on a desk plate;

FIG. 8 is an illustrative view showing one example of a menu displayed in a menu displaying area of a computer screen shown in FIG. 7;

FIG. 9 is an illustrative view showing one example of an image displayed in an image displaying area of the computer screen shown in FIG. 7;

FIG. 10 is an illustrative view showing another example of the menu displayed in the menu displaying area of the computer screen shown in FIG. 7;

FIG. 11 is an illustrative view showing another example of the image displayed in the image displaying area of the computer screen shown in FIG. 7;

FIG. 12 is an illustrative view showing one example of an image displayed in a flowing manner in the image displaying area of the computer screen shown in FIG. 7;

FIG. 13 is an illustrative view showing one example of flowing data;

FIG. 14 is an illustrative view for describing inertia, a fluid resistance, and a color friction resistance added to the pointing device;

FIG. 15 is a flowchart showing a process to be executed in an LED control circuit of the pointing device shown in FIG. 1;

FIG. 16 is a flowchart showing a click detecting process of a peripheral device-use signal processing apparatus shown in FIG. 1;

FIG. 17 is a flowchart showing a resistance value outputting process of the peripheral device-use signal processing apparatus shown in FIG. 1;

FIG. 18 is a flowchart showing a main process of a computer shown in FIG. 1;

FIG. 19 is a flowchart showing a memory updating process of the computer shown in FIG. 1;

FIG. 20 is a flowchart showing one portion of a rendering/motor driving process of the computer shown in FIG. 1;

FIG. 21 is a flowchart showing another portion of the rendering/motor driving process of the computer shown in FIG. 1;

FIG. 22 is a flowchart showing one portion of a menu operating process of the computer shown in FIG. 1;

FIG. 23 is a flowchart showing another portion of the menu operating process of the computer shown in FIG. 1; and

FIG. 24 is a flowchart showing still another portion of the menu operating process of the computer shown in FIG. 1;

### DETAILED DESCRIPTION OF THE PREFERRED EMBODIMENTS

A sensory drawing apparatus 10, which is one embodiment of the present invention, includes a desktop apparatus 12. The desktop apparatus 12 is provided with a desk plate 14 and a linear induction motor (hereinafter briefly referred to as a “linear motor”) 16. In addition, in the sensory drawing apparatus 10, provided are an X direction-use inverter 18a and a Y direction-use inverter 18b for supplying voltage (power) to the linear motor 16.

It is noted that for the sake of illustration, it is described in such a manner that there is a gap between the desktop plate 14 and a stator of the linear motor 16. However, in reality, the desk plate 14 is mounted on the stator of the linear motor 16.

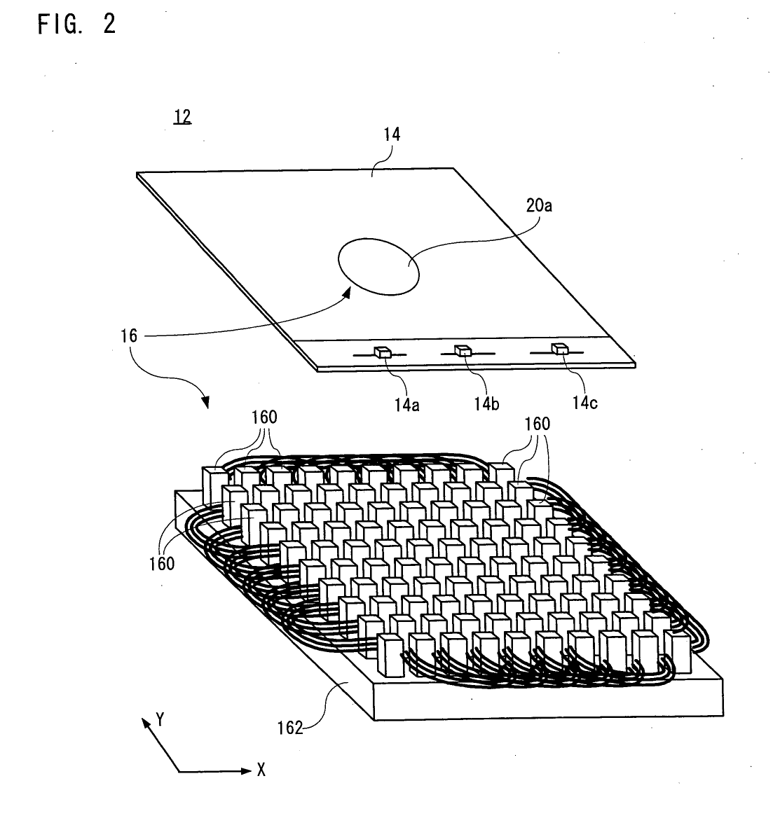

FIG. 2 is an illustrative view showing structure of the desktop apparatus 12. As shown in this FIG. 2, on the desk plate 14, mounted are three slide resistors 14a, 14b, and 14c. In FIG. 2, for the sake of simplicity, only one portion (adjusting knob) of the slide resistors 14a, 14b, and 14c is shown. These slide resistors 14a-14c are electrically connected to a peripheral device-use signal processing apparatus 26 described later. In addition, in each of the slide resistors 14a-14c, when its adjusting knobs are moved to the extreme left, a resistance value becomes a minimum, and on the contrary, when the adjusting knobs are moved to the extreme right, the resistance value becomes a maximum.

It is noted that the slide resistors 14a-14c need not to be mounted on the desk plate 14, and these resistances may be provided separately.

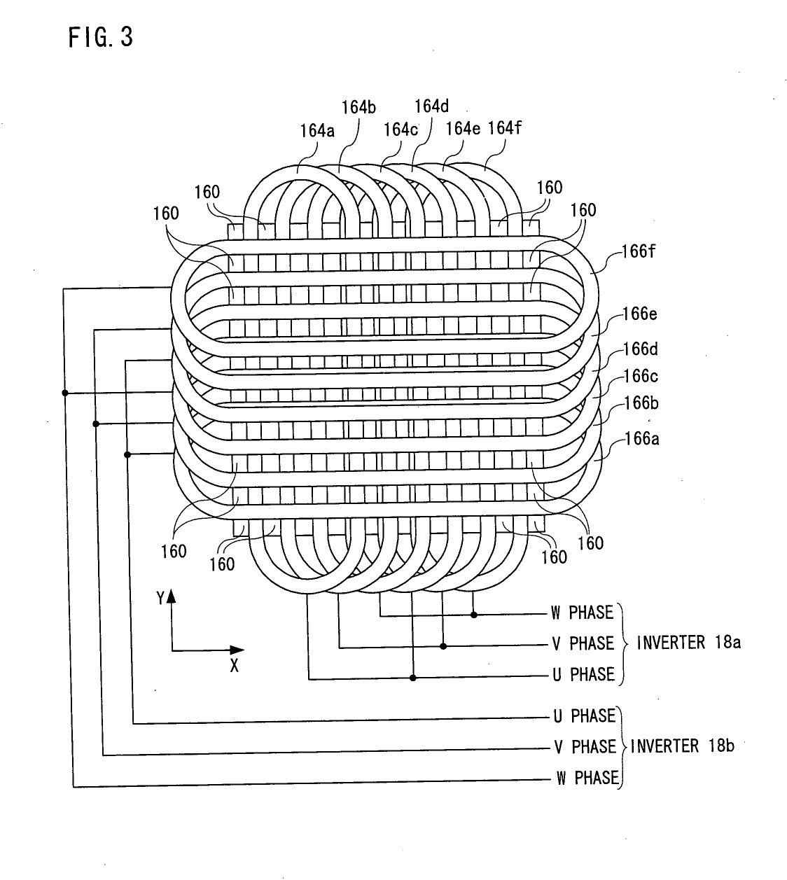

Furthermore, as shown in FIG. 2, the linear motor 16 includes a plurality (in this embodiment, 100) of stator cores 160 and yokes 162, and a plurality of stator cores 160 are aligned and arranged in a matrix manner by each predetermined number (10) in the horizontal (X) and the vertical (Y) directions. Although difficult to understand in FIG. 2, in each of the stator cores 160, a plurality of windings (stator coils) 164a-164f and 166a-166f are wound (see FIG. 3) in the two directions, that is, the X direction and the Y direction.

Each of the windings 164a-164f and the windings 166a-166f is commonly wound around a plurality of cores 160 in such a manner as to pass through the adjacent stator cores as shown in FIG. 3. In an X-axis direction, the winding 164a and the winding 164d are connected in series, and its one edge is connected to a U-phase of the inverter 18a. In addition, the winding 164b and winding 164e are connected in series, and its one edge is connected to a V-phase of the inverter 18a. Furthermore, the winding 164c and the winding 164f are connected in series, and its one edge is connected to a W-phase of the inverter 18a. In addition, although not illustrated, each of the other edge is joined with each other, that is, is Y-connected.

On the other hand, in a Y axis direction, the winding 166a and winding 166d are connected in series, and its one edge is connected to the U-phase of the inverter 18b. In addition, the winding 166b and winding 166e are connected in series, and its one edge is connected to the V-phase of the inverter 18b. Furthermore, the winding 166c and the winding 166f are connected in series, and its one edge is connected to the W-phase of the inverter 18b. In addition, although not illustrated, each of the other edge is joined with each other, that is, is Y-connected.

It is noted that as the linear motor 16, a two-directional linear motor, which is disclosed in Japanese Patent laying-open No. 2975659 laid-open on Sep. 3, 1999, may be used.

A computer 28 applies a driving voltage to at least one of the inverter 18a and the inverter 18b via the peripheral device-use signal processing apparatus 26 provided at a front of the inverter 18a and the inverter 18b. As a consequence, a traveling magnetic field is occurred at least in one of the X axis direction and the Y axis direction. That is, in the linear motor 16, within a range of in which the stator cores 160 are arranged, it is possible to allow the traveling magnetic field to be occurred toward an arbitrary direction (two-dimensional directions).

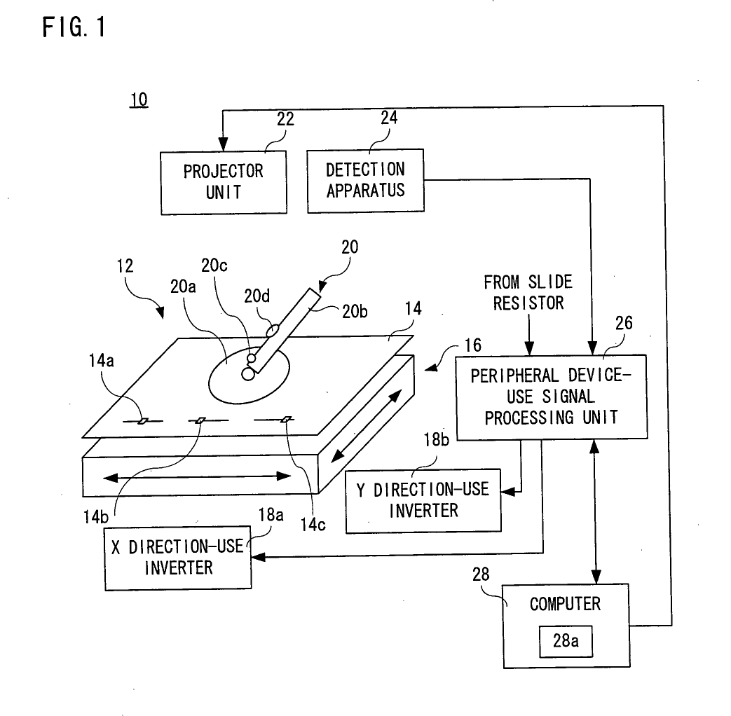

Returning to FIG. 1, the sensory drawing apparatus 10 includes a pointing device 20, and the pointing device 20 is mounted on the desk plate 14. In the pointing device 20, a conductive material 20a such as copper, aluminum, or brass formed in a disk shape is provided, for example. This conductive material 20a is a rotor of the linear motor 16.

It is noted that the shape of the conductive material 20a is not to be limited to the disk shape, and may be formed in a plate shape of a quadrangle (square, rectangular).

In addition, in the pointing device 20, provided is a holding portion (hereinafter referred to as a “pen inputting portion”.) 20b attached to a hand and finger or held by the hand and finger of a user, and this pen inputting portion 20b is joined to the conductive material 20a described above. Furthermore, in the pen inputting portion 20b, provided are an infrared LED 20c and a depressing button 20d. As one example, the infrared LED 20c is provided in the vicinity of a joint portion between the conductive material 20a and the pen inputting portion 20b, and the depressing button (hereinafter briefly referred to as a “button”.) 20d is provided in a location capable of being depressed by an index finger, and etc., in a case that the user holds the pen inputting portion 20 by the hand and finger. It is noted that the infrared LED 20c may be provided in an arbitrary location of the conductive material 20a or the pen inputting portion 20b as long as in a location capable of detecting its infrared light by a detection apparatus 24 described later. In addition, in place of the button 20d, a sensor such as a touch sensor may be used.

It is noted that in this embodiment, the reason why the infrared LED 20c is provided in the vicinity of a joint portion between the conductive material 20a and the pen inputting portion 20b is that a center or an approximate center of the conductive material 20a is to be recognized as a location instructed by the user, and the joint portion is arranged in an approximate center of the conductive material 20a.

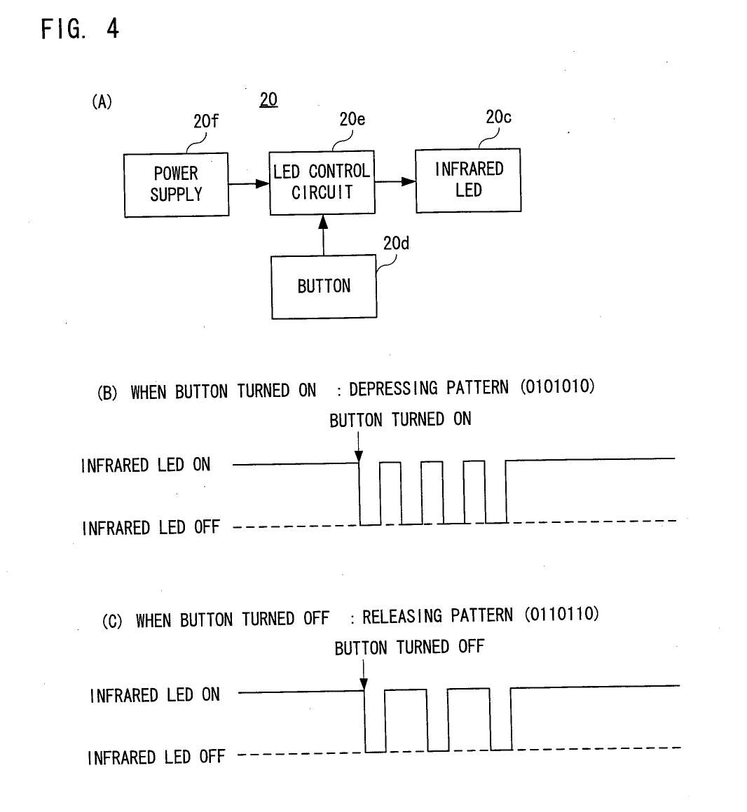

In FIG. 4(A), it is shown electrical structure of the pointing device 20. Referring to this FIG. 4(A), the pointing device 20 includes a LED control circuit 20e, and to the LED control circuit 20e, a power (direct-current voltage) is applied from a power supply 20f. It is noted that as the power supply 20f, a battery (primary battery or secondary battery) may be used. In addition, to the LED control circuit 20e, the above-described infrared LED 20c and button 20d are connected.

The LED control circuit 20e controls a turning on/off, that is, a blinking, of the infrared LED 20c by supplying/suspending the direct-current voltage applied from the power supply 20f to the infrared LED 20c. In this embodiment, the LED control circuit 20e allows a infrared LED 20c to normally continuingly turn on, and to blink in a pattern different to each other depending on the turning on/off of the button 20d.

When the button 20d is depressed, in response thereto, the LED control circuit 20e allows the infrared LED 20c to turn off, on, off, on, off, on, off in a time series manner as shown in FIG. 4(B), for example. Provided that a case that the infrared LED 20c is turned on is “1”, and a case that the infrared LED 20c is turned off is “0”, the infrared LED 20c is blinked according to a pattern of “0101010” (hereinafter referred to as a “depressing pattern”). On the other hand, when the button is turned off, in response thereto, as shown in FIG. 4(C), the LED control circuit 20e allows the infrared LED 20c to turn off, on, on, off, on, on, off in a time series manner. That is, the infrared LED 20c is blinked according to a pattern of “0110110” (hereinafter referred to as a “releasing pattern”). However, the infrared LED20c is blinked according to this releasing pattern only in a case that after the button 20d is turned on once, and turned off later. Therefore, in a case of being tuned off, that is, a case that the button 20d is not operated by the user, the infrared LED 20c is not blinked according to the releasing pattern.

It is noted that this pattern is only illustrative, and is not always the case. The infrared LED 20c may be blinked according to a different pattern depending on when the button 20d is turned on or off.

In addition, a period during which the infrared LED 20c is blinked according to the pattern is some (two to three) milliseconds.

Furthermore, in this embodiment, it is shown a case that the pointing device 20 having the pen inputting portion 20b provided with one button. However, the pen inputting portion 20b may be provided with two or more buttons. In addition, in place of the pen inputting portion 20b, an inputting portion shaped and structured of a computer mouse may be provided. In a case of providing two or more buttons, the infrared LED 20c may be blinked by changing the pattern between a time of turning on and off even between the buttons so that each button is identified. In a case of providing the inputting portion shaped and structured of the computer mouse, for example, at least there are provided a left click-use button and a right click-use button so that the LED 20c may be blinked according to different patterns (four patterns) depending on turning on/off of the left click-use button and turning on/off of the right click-use button.

Regarding the pointing device 20 thus structured, the pen inputting portion 20b is held by the user, and the pointing device 20 is moved on the desk plate 14. In a certain case, the pointing device 20 receives the turning on/off of the button 20d. In addition, as a result of the traveling magnetic field being occurred on a stator side of the above-described linear motor 16, the conductive material 20a is moved on the desk plate 14, thus possible to add (apply) a force to the pointing device 20. That is, it is possible to present an arbitrary force to the hand and finger of the user who holds the pen inputting portion 20b.

Returning to FIG. 1, above the desktop apparatus 12 and the pointing device 20, the projector unit 22 and the detection apparatus 24 are provided in a predetermined manner in a predetermined location. The projector unit 22 displays an image on the desk plate 14 of the desktop apparatus 12 according to an instruction from a computer 28 described later.

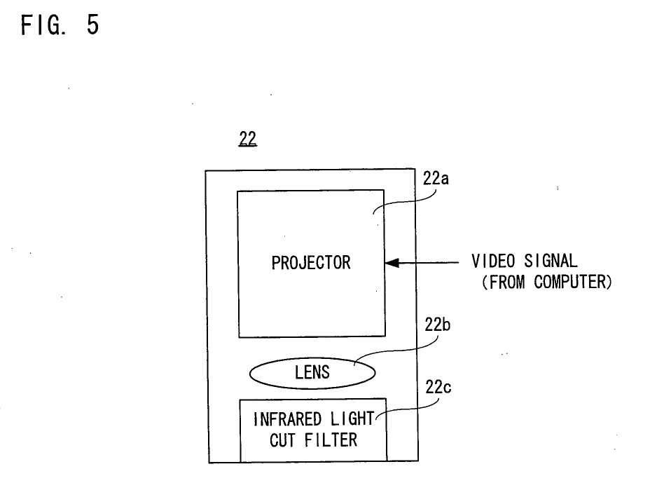

FIG. 5 is an illustrative view showing specific structure of the projector unit 22. As shown in FIG. 5, to the projector unit 22, provided is a projector 22a, and to the projector 22a, applied is a video signal (RGB signal, for example) from the computer 28. In addition, to the projector 22, provided are a lens 22b and an infrared light cut filter 22c in this order on a side that the projector 22a and the desk plate 14 face, and toward the desk plate 14 from the projector 22a. The lens 22b enlarges the image projected from the projector 22a. Therefore, an enlarged image is displayed onto the desk plate 14. The infrared light cut filter 22c cuts an infrared light of the projector 22a to be included in the image displayed on the desk plate 14. Consequently, this is not to give adverse impact on a detection of the infrared light of the pointing device 20 described later.

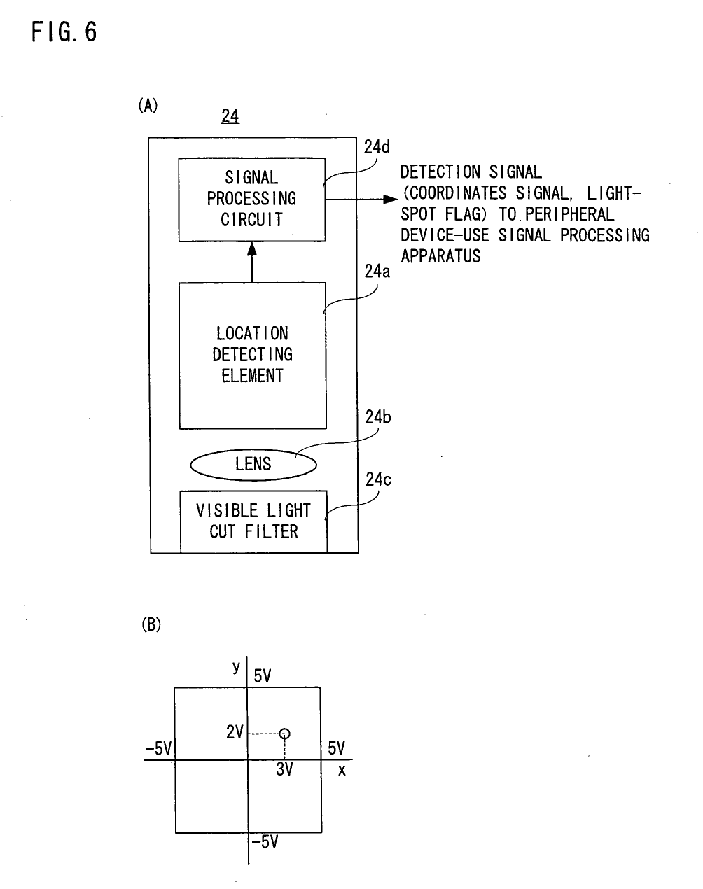

FIG. 6(A) is an illustrative view showing specific structure of the detection apparatus 24. The detection apparatus 24 includes a location detecting element 24a, and the location detecting element 24a detects the infrared light input via a visible light cut filter 24c and the lens 24b. The lens 24b and the visible light cut filter 24c are provided in this order on a side that the location detecting element 24a and the desk plate 14 face, and toward the desk plate 14 from the location detecting element 24a. In this embodiment, the infrared light is irradiated from the above-described pointing device 20. The visible light cut filter 24c is provided in order that a visible light, and etc., regarding the video displayed on the desk plate 14 do not affect the detection of the infrared light. The lens 24b is provided for allowing all ranges (size) of the desk plate 14 and the size of the location detecting element 24a to agree in a pseudo manner. Therefore, the infrared light radiated from any portion of the all ranges of the desk plate 14 is irradiated onto the location detecting element 24a by being passed through the lens 24b. The location detecting element 24a has an element surface as indicated by a square frame in FIG. 6(B), and when the infrared light is irradiated, in response to an irradiated location, outputs a coordinates signal of a voltage value to the signal processing circuit 24d.

In a case that the infrared light is irradiated onto a location indicated by a circle in FIG. 6(B), for example, the coordinates signal of (x, y)=(3V, 2V) is applied to the signal processing circuit 24d. The signal processing circuit 24d applies processes such as a noise removal and an amplification to this voltage signal (coordinates signal), and etc. and applies the voltage signal to the peripheral device-use signal processing apparatus 26 described later. In addition, the signal processing circuit 24d applies a light-spot detecting flag to the peripheral device-use signal processing apparatus 26. Herein, the light-spot detecting flag is numerical value data, which is “1” or “0”. In addition, in a case of detecting the infrared light, the signal processing circuit 24d outputs the light-spot detecting flag of the data value “1”, and in a case of not detecting the infrared light, outputs the light-spot detecting flag of the data value “0”.

It is noted that as the location detecting element 24a and the signal processing circuit 24d, a “position sensitive detector (product number:C7339)” manufactured by Hamamatsu Photonics K.K. may be used.

Returning to FIG. 1, the sensory drawing apparatus 10 is further provided with the peripheral device-use signal processing apparatus 26 and the computer 28. The peripheral device-use signal processing apparatus 26 is structured of a microchip or a DSP, and in receipt of the voltage value from the slide resistors 14a-14c, converts this value into a resistance value of the slide resistors 14a-14c. In addition, the peripheral device-use signal processing apparatus 26 inputs digitally-converted resistance value data into the computer 28. The peripheral device-use signal processing apparatus 26 and the computer 28 are connected via a serial bus such as an RS 232C. Furthermore, the peripheral device-use signal processing apparatus 26 applies the coordinates signal applied from the detection apparatus 24 to the computer 28 as it is, and applies to the computer 28 information on whether the button 24d, which is provided in the pointing device 20, is depressed (turned on) or released (turned off), that is, depressing information or releasing information (hereinafter may generally be referred to as “click information”) based on a light-spot flag applied from the detection apparatus 24.

In addition, in receipt of the voltage value (two values of X direction and Y direction) that corresponds to a driving frequency of the motor applied from the computer 28, the peripheral device-use signal processing apparatus 26 applies the voltage value to each of the inverter 18a and the inverter 18b.

The computer 28 is a general-purpose computer such as a PC (personal computer) or a work station, controls a driving of the linear motor 16 (inverters 18a, 18b), controls a displaying of the video and the image onto the desk plate 14, and so forth. The control of driving the linear motor 16 is performed based on the image to be displayed on the desk plate 14, the resistance value data, the coordinates signal, the click information, and etc applied from the peripheral device-use signal processing apparatus 26. This control method will be described later in detail.

In addition, the computer 28 displays a screen (computer screen) including the video or the image onto the desk plate 14 via the projector unit 22. The computer 28 includes a storage medium (memory) 28a such as a hard disk, and into the memory 28a, stored are data (image data) regarding the computer screen displayed on the desk plate 14, and etc.

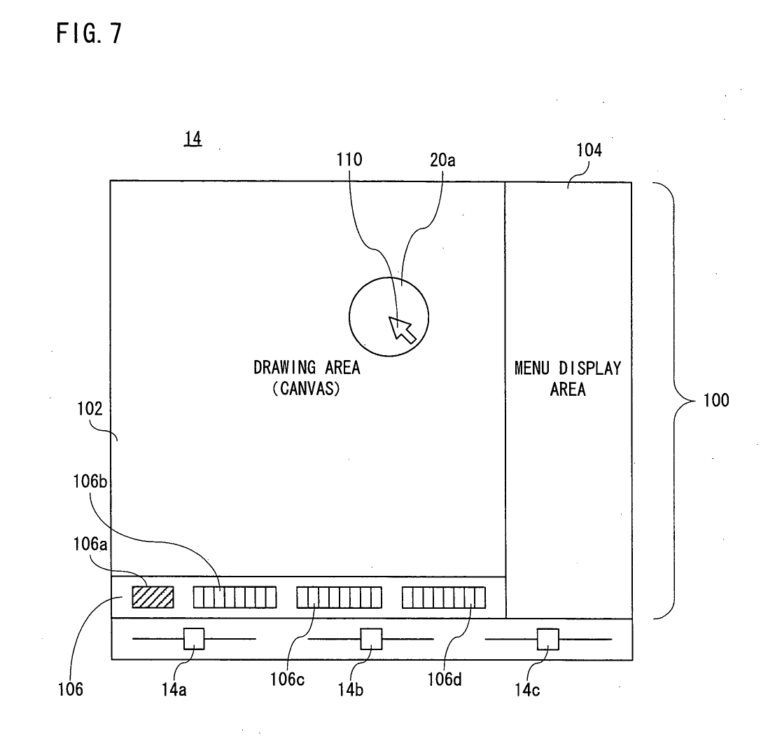

When the sensory drawing apparatus 10 is started, a desktop is initialized, and a screen (computer screen) 100 as shown in FIG. 7 is displayed on the desk plate 14, for example. On the computer screen 100, provided are an image display area (canvas) 102 for displaying an image (point, line, surface, and etc.,) drawn by the user, and a menu display area 104 for displaying a tool drawn necessary in a case that the user draws the image in the image display area 102.

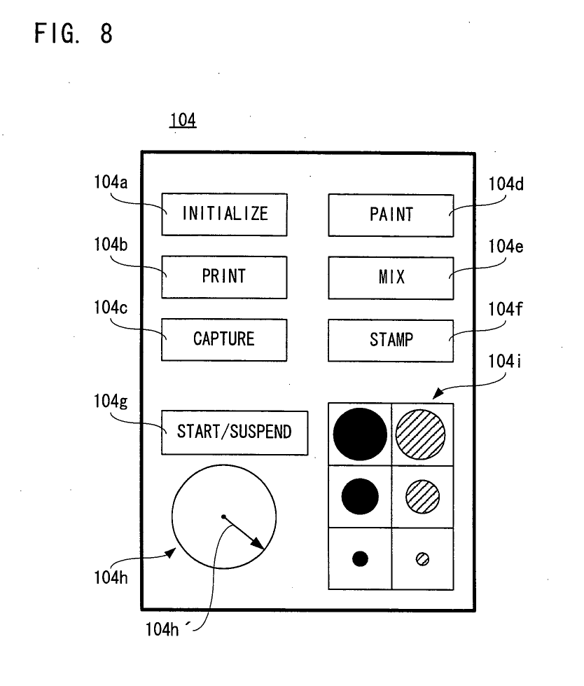

As shown in FIG. 8, in the menu display area 104, displayed are buttons or icons 104a, 104b, 104c, 104d, 104e, 104f, and 104g. The button 104a is operated in a case of initializing the image display area 102. When the image display area 102 is initialized, a background in monotone such as white is displayed in the entire image display area 102, for example. The button 104b is operated in a case of printing the image displayed in the image display area 102. Although omitted in FIG. 1, it is possible to connect a printer as a peripheral device to the computer 28, and therefore, it is possible to print the image displayed in the image display area 102.

The button 104c is operated in a case that the image is captured by a camera (not shown), and the captured image is displayed in the image display area 102. As the camera, a CCD camera (USB camera) that uses an imaging device such as a CCD may be used, for example. Although omitted in FIG. 1, this CCD camera is arranged in a location capable of capturing a face image of the user who uses the sensory drawing apparatus 10, and in response to an operation of the button 104c, inputs a captured image into the computer 28, for example. The computer 28 displays the captured image input from the CCD camera into the image display area 102 of the desk plate 14.

It is noted that an arranging location or a captured object of the CCD camera is arbitrarily settable. That is, the CCD camera needs not to be directly connected to the computer 28, and may be connected via a network such as an internet, an intranet, and etc. In addition, a captured object (subject) is not limited to a face of the user, and may be another person or scenery. Furthermore, it is not needed to obtain the captured image in a real time, and it is possible to display the captured image obtained (captured) in advance corresponding to a capturing operation.

The buttons 104d, 104e, and 104f are buttons for selecting each mode in a case of drawing. The button 104d is operated in a case of setting a mode (paint mode) that the user freely draws the image into the image display area 102. When this paint mode is set, a plurality of icons for selecting kinds of brushes used for drawing are displayed in an icon display area 104i. In this embodiment, prepared are the icons regarding six kinds of brushes having at least one of a size (large, medium, small) and a transparency being set differently. In addition, to each icon (brush), a softness, too, of an edge at a time of drawing the point or the line is separately set. That is, in a case of a low edge softness, that is, in a case that the edge is hard, the point and an edge of line are displayed in a strict manner. On the other hand, in a case that the softness of the edge is large, the point and the line are displayed in a rounded manner.

It is noted that in FIG. 8, the size of an image pattern (circle) indicates a size of brush (thickness), and in addition, the image pattern painted out in black inside the image pattern indicates that this pattern has a lower transparency than a dotted-lined image pattern.

Furthermore, for the sake of simplicity, in this embodiment, six kinds of brushes are prepared. However, a wider variety of brushes may be prepared. In this case, it becomes possible to select a difference of the edge that appears in the drawn point and line with not only the brush of the round image pattern but also a brush of a square image pattern being prepared.

Therefore, the user is capable of selecting a desired brush from the icon display area 104i so as to draw a picture in the image display area 102, that is, the canvas, by the selected brush. However, the color used in drawing the picture is settable and changeable by the user, as required, by using the above-described slide resistors 14a-14c. In this embodiment, the resistance value of the slide resistor 14a corresponds to a hue, the resistance value of the slide resistor 14b corresponds to a saturation, and the resistance value of the slide resistor 14c corresponds to a luminance, for example. Therefore, as a result of the resistance values of the slide resistors 14a-14c being rendered changeable, the colors that correspond to the selected hue, saturation, and brightness are determined.

Returning to FIG. 7, below the image display area 102, provided is a display area (color attribute display area) 106 that indicates an attribute of color. In this color attribute display area 106, provided further are a color display area 106a for displaying the color being selected, a hue display area 106b for displaying the hue, a saturation display area 106c for displaying the saturation, and a luminance display area 106d for displaying the luminance. Therefore, the user looks at the color attribute display area 106 so as to easily set color when adjusting the slide resistors 14a-14c.

Furthermore, in a location instructed by the pointing device 20, displayed is a pointer 110 such as a mouse pointer. That is, the pointer 110 is displayed in a location on the screen that corresponds to a location where the infrared LED 20c is detected. However, in FIG. 7, for the sake of simplicity, only the conductive material 20a of the pointing device 20 is shown.

In the paint mode, when the user uses and drags the pointing device 20 on the desk plate 14 (image display area 102), a line of the selected color is drawn or rendered in the image display area 102 in response thereto. More specifically, in the paint mode, if a location (current location) of the pointing device 20 is detected, the selected color is made to be attached in the detected current location, that is, a location indicated by the pointer in a range (area) that corresponds to the size of the selected brush. In this embodiment, a dragging means to move the pointing device 20 with the operation button 20d being turned on. Hereinafter, the same is true. However, in this painting mode, the selected color is made to be attached in the current location instructed by the painting apparatus 20 so that in a case that the color is already (in advance) painted in the corresponding location, the color is attached thereon.

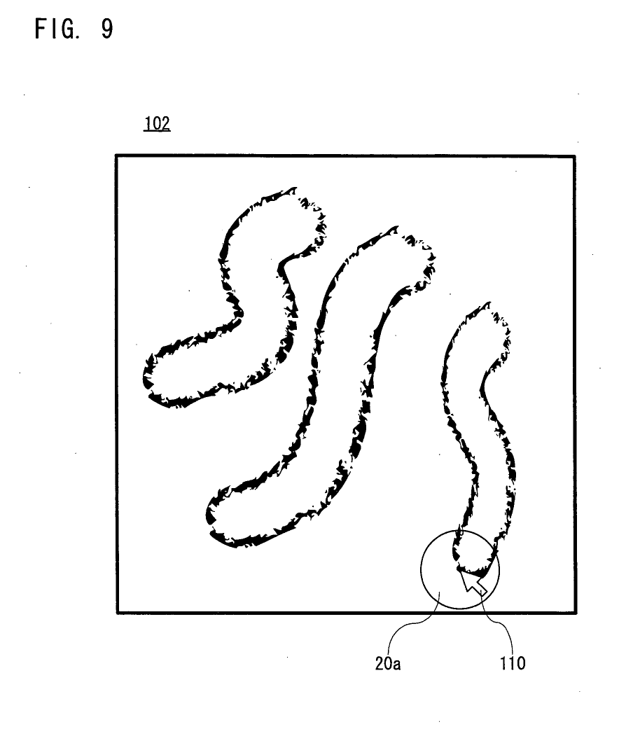

For the sake of illustration, it is not possible to express the color. However, in the paint mode, as shown in FIG. 9, it is possible to draw the desired image, and etc. It is noted that a difference in thickness of line means that the size of the selected brush is different.

Returning to FIG. 8, the button 104e is operated in a case of setting a mode (mixing mode) for mixing the color. In a case that this mixing mode is set, too, similar to the above-described paint mode, a plurality of icons for selecting kinds of brushes are displayed in the icon display area 104i. Therefore, the user is capable of selecting the desired icon, that is, the brush by operating the pointing device 20.

In this mixing mode, when the user uses and drags the pointing device 20 on the image already drawn or rendered (displayed) in the image display area 102, the colors already drawn or rendered are mixed to each other. More specifically, if dragged in the mixing mode, the color in a location instructed by the pointing device 20 (pointer 110) inside the image display area 102, at a time of starting dragging, is copied into a work area of the memory 28a, for example, by the range (area) that corresponds to the size of the brush. In addition, at every time that the image display is updated, the transparency set to the selected brush is applied to the copied color, and the color already drawn or rendered in a location currently indicated by the pointing device 20 (pointer 110) is made to be mixed and attached to the location. Thereby, a manner of mixing the color is shown.

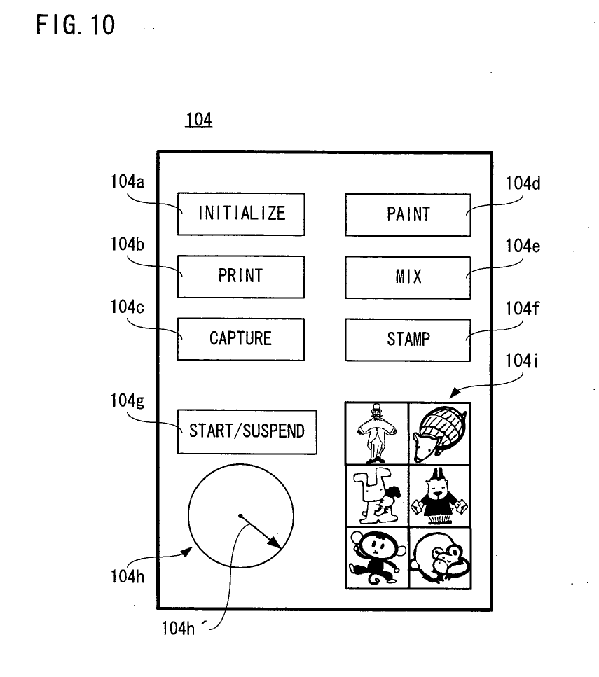

The button 104f is operated in a case of a mode (hereinafter, referred to as a “stamp mode”) of attaching into a desired location of the image display area 102 an image (in this embodiment, referred to as a character image) stored in the memory 28a in advance. When this stamp-mode is set, as shown in FIG. 10, an icon of a reduced image (thumbnail image) regarding the character image stored in the memory 28a in advance is displayed in the icon display area 104i.

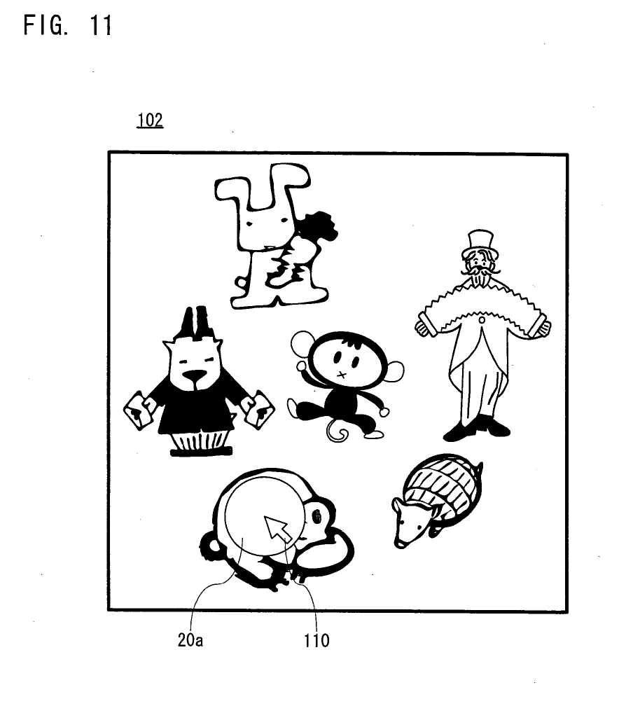

When the user uses the pointing device 20 so as to select the desired thumbnail image, and thereafter, clicks or drags the desired location of the image display area 102, the character image that corresponds to the selected thumbnail image is attached into a clicking or dragging location, for example. Therefore, as shown in FIG. 11, the character image prepared in advance is displayed in the image display area 102. However, in FIG. 11, in order that the conductive material 20a and the pointer 110 are easily understood, the conductive material 20a and the pointer 110 are overwritten into the character image. However, in reality, the character image is displayed on the conductive material 20a in order the image is displayed on the desk plate 14 by the projector 22a.

It is noted that in this embodiment, for the sake of simplicity, six kinds of character images are prepared, and the icon of the thumbnail image is made to be displayed. However, a wider variety of character images may be prepared. In addition, the image is not limited to the character image, and it may be possible that an arbitrary image such as a photograph, a painting, a poster, and etc., are stored, and in a case that the stamp mode is selected, the icon of the thumbnail image regarding such the image is made to be displayed in the icon display area 104i, and the arbitrary image is attached to the image display area 102 according to an operation of the user.

Furthermore, if the button 104g shown in FIG. 8 and FIG. 10 is operated, it becomes possible to display the image displayed in the image display area 102 in a flowing manner, and in addition, in a case that the image is already displayed in a flowing manner, the flow is suspendable. Below the button 104g, provided is a flow setting area 104h, and as a result of a direction and a size of an arrow 104h′ shown in the flow setting area 104h being set, it becomes possible to set the direction and its intensity (speed) of flowing the entire image. In a case of setting (changing) the direction and the intensity of flowing the entire image, by using the pointing device 20, for example, the button 104g is operated (clicked), and the flow of the image is temporarily suspended. Next, by dragging the pointing device 20, a tip of the arrow 104h′ is directed toward a desired flowing direction, and a length of the arrow 104h′ is changed, for example. Furthermore, when the button 104g is clicked, the entire image is displayed in a flowing manner by the changed direction and the intensity.

However, it is also possible to set the direction and the intensity of flowing the entire image not by dragging but by clicking. If, as a result of the desired location within the flow setting area 104h being clicked, the tip of the arrow 104h′ is moved to a clicked location, it becomes possible to set the direction and the intensity of flowing the entire image.

In addition, it is also possible to set the direction and the intensity of flowing the entire image in a real time by changing the size and the direction of the arrow 104h′ without suspending the flow of the entire image.

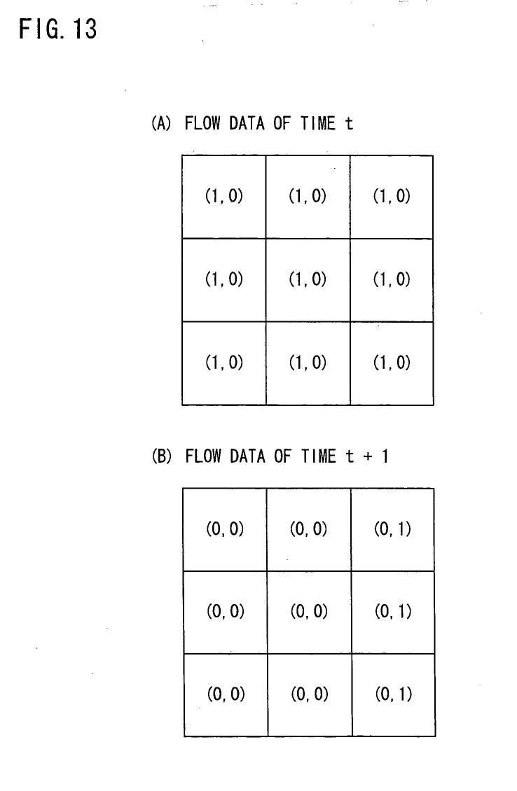

Herein, in this embodiment, in order to express the flow of the image, in each of all pixels (512 pixels×512 pixels, for example) of the image display area 102 (VRAM provided inside the computer 28, to be exact), stored in the memory 28a is flow data for determining a moving amount in a certain point in time by a predetermined time period (20 seconds-30 seconds). This is for applying a change to the flow, not for flowing the image as a whole. For the sake of simplicity, descriptions will be made only regarding an area of 3 pixels×3 pixels. The flow data F(t) in a certain time t is shown as in FIG. 13(A), for example. Herein, one pixel corresponds to a frame of a small square, and data written in such a manner as to correspond to each pixel is vector data. This vector data is data for determining a moving (flowing) direction and a moving (flowing) amount regarding the X-axis direction (horizontal direction) and the Y-axis direction (vertical direction). The moving direction is a left direction if the number is positive and a right direction if the number is negative in the X-axis direction, and a downward direction if the number is positive and an upward direction if the number is negative in the Y-axis direction. In addition, the moving amount is determined by a magnitude (absolute value) of a numerical value, and the numerical value indicates the number of pixels that move.

Therefore, in a subsequent time t+1, the entire image is moved to left by one pixel according to the flow data of time t. In addition, if the flow data F(t+1) of the time t+1 is shown as in FIG. 13(B), in a time t+2, the pixel in the line on the extreme right is to be moved in the downward direction by one pixel.

However, as described above, it is possible to change the direction and the intensity of the flow of the entire image by operating the arrow 104h′ inside the flow setting area 104h so that these coefficients are applied to the flow data F(t), which results in the flow data F(t) being adjusted. The adjusted flow data F′(t) is calculated according to Equation 1 where a coefficient of the direction regarding the flow of the entire image is “R”, and a coefficient of the intensity of the flow is “S”.
F′(t)=R·S·F(t) [Equation 1]

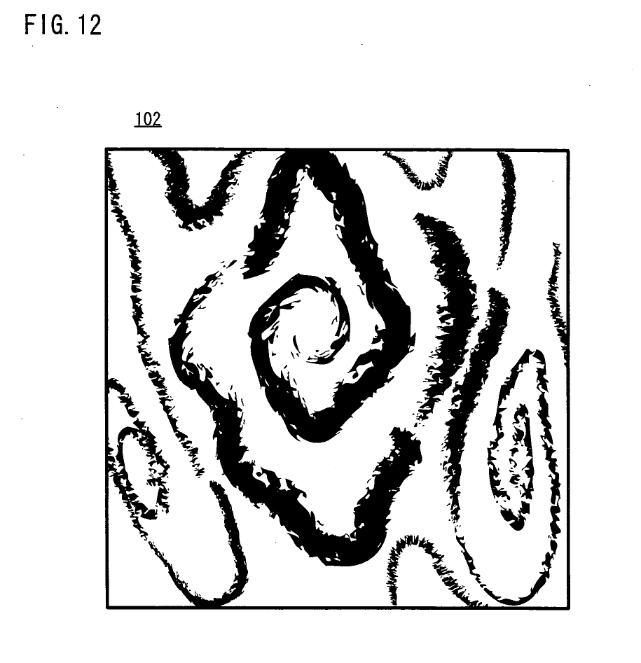

The entire image is displayed in a flowing manner by such the corrected flow data F′(t) so that as shown in FIG. 12, it is possible to display in the image display area 102 an image that expresses a flow having one portion swirling, for example. Therefore, as a result of simply attaching the color, and mixing the colors to each other, it is possible to enjoy a change of the image by the flow, in addition to drawing the image.

It is noted that in this embodiment, a manner in which the image is flown according to the flow data prepared in advance is expressed. However, it is possible that the flow is contained by a movement of the pointing device 20 (brush), and the image is converted as a result of a real time calculation, which adopts a fluid simulation such as swirling, being performed, for example. An example of such the real time fluid simulation is disclosed by Jos Stam, ” A simple Fluid Solver based on the FFT”, Journal of Graphics Tools, Volume 6, Number 2, 2001, 43-52.

Thus, the screen display by the computer 28 is controlled. In addition, the computer 28 detects an operation by the user, that is, a location (including its movement) of the pointing device 20, and a turning on/off of its buttons 20d, and applies to the pointing device 20 a resultant force of a force (inertia force) by the weight of the color drawn or rendered by the pointing device 20, a force (force by a fluid resistance) by the flow of the image, and a force (force by a color friction resistance) by a change of the above color on the canvas (image display area 102). Herein, the weight of color is defined in advance as an amount (weight) that changes corresponding to the color.

However, the resultant force need not always to include all the inertia force, the force (force of fluid resistance) by the fluid resistance, and the force (force of color friction resistance) by the color friction resistance, and may include at least one of the three forces.

The computer 28 determines (calculates) the strength and the direction of the force to be applied to the pointing device 20, and calculates the frequency for driving the linear motor 16 necessary for occurring the force, and in addition, the voltage value (driving voltage of the inverters 18a and 18b) corresponding to the frequency. Furthermore, a symbol (positive, negative) of the voltage, too, is determined corresponding to the direction of the force. In addition, the computer 28 applies to the peripheral device-use signal processing apparatus 26 the driving voltage of the inverters 18a and 18b. In response thereto, the peripheral device-use signal processing apparatus 26 applies the driving voltage to the inverters 18a and 18b. Therefore, the stator 160 is excited by at least one of the stator coils in the X-axis direction and the Y-axis direction, and as a result, the traveling magnetic field is occurred. This excites an eddy current in the conductive material 20a in a direction that prevents this traveling magnetic field. Therefore, as a result of an interaction between the traveling magnetic field, the conductive material 20a is translated. This results in the conductive material 20a being moved on the desk plate 14, and thus, possible to act (add) the force onto the hand and finger of the user who holds the pointing device 20.

In a case that the pointing device 20 (conductive material 20a) is dragged, as shown in FIG. 4(A), the inertia by the weight of the color (including the color mixed and attached) to be attached is added, for example. That is, the force is applied to a direction opposite to a moving direction of the pointing device 20. This inertia force Fi is calculated according to Equation 2.
Fi=−m·a [Equation 2]

It is noted that “m” is a weight parameter, and “a” is an acceleration component.

Herein, the weight parameter “m” is changed according to the size of the brush and the brightness of the color. In this embodiment, in a case that the brush is large, a value of the weight parameter “m” is rendered large, and on the contrary, in a case that the brush is small, the value of the weight parameter “m” is rendered small. In addition, in a case that the brightness is high, that is, in a case that the color is close to white, the value of the weight parameter “m” is rendered small, and in a case that the brightness is low, that is, in a case that the color is close to black, the value of the weight parameter “m” is rendered large. That is, the weight parameter “m” is calculated according to Equation 3.
m=(1−L)·k·S [Equation 3]

It is noted that “L” is the brightness, “k” is an arbitrary coefficient, and “S” is the size of the brush.

In addition, the acceleration component “a” shown in Equation 2 is a moving acceleration of the brush, that is, the pointing device 20, and is calculated by applying second-order derivative to a moved distance in a unit time period (predetermined time period for obtaining location information) of the pointing device 20.

Furthermore, in this embodiment, the weight of color is made to change corresponding to the brightness at a time of converting a color value into a monochrome value. However, the weight of color may be changed by one of or in an arbitrary combination of any one of three color elements, that is, the hue, a saturation, and the luminance. The conversion into the monochrome value is performed according to Equation 4.
Luminance=red component (R)·0.299+green component (G)·0.587+blue component (B)·0.114 [Equation 4]

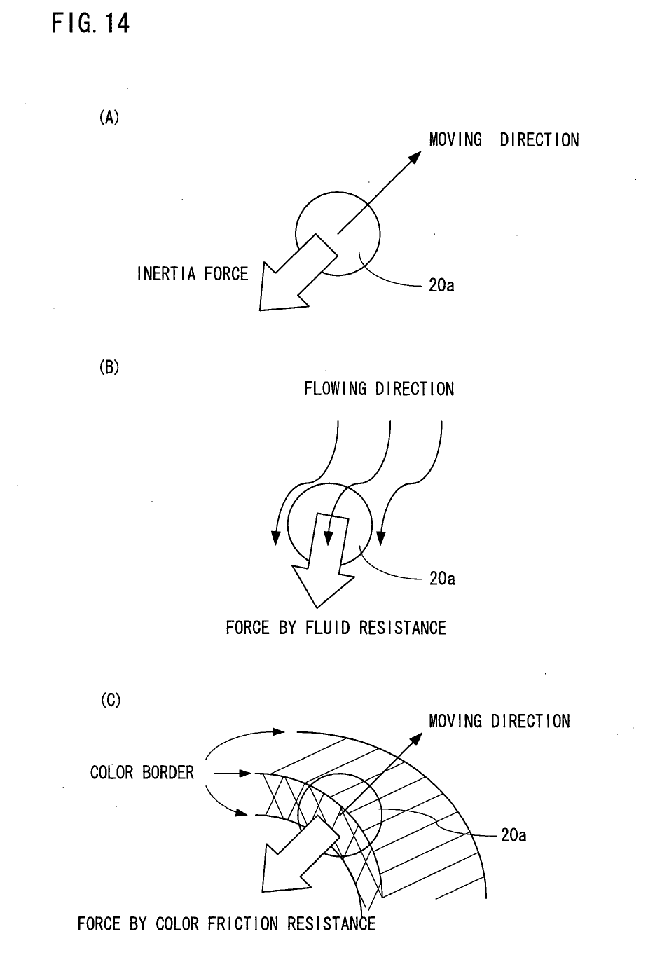

In addition, in a case that the pointing device 20 (conductive material 20a) is dragged, as shown in FIG. 14(B), the force by the flow (force of flow resistance), that is, the force of fluid resistance, is added to the direction to which the image flows. This force of fluid resistance Ff is calculated according to Equation 5.
Ff=−k·F′(t) [Equation 5]

It is noted that “k” is an arbitrary coefficient, and F′(t) is data that corrects the flow data F(t) according to an entire flow as described above. It is noted that in order to apply the force to the pointing device 20 (conductive material 20a), the corrected flow data F′(t) is, in reality, an average value within a range (area) determined by the size of the brush, using the pointer 110 as a center. Furthermore, the larger the brush, the larger the coefficient “k”, and the smaller the brush, the smaller the coefficient “k”.

Furthermore, in a case that the pointing device 20 (conductive material 20a) is dragged, and a border of the color on the image already drawn (displayed) is traversed, as shown in FIG. 14(C), the force by a difference (change) in color, that is, a force of color change resistance (force of color friction resistance), is added. Although not possible to express the color in FIG. 14(C), a dotted line indicates the difference in color. This force of color friction resistance Fc is calculated according to Equation 6.
Fc=−k·R [Equation 6]

It is noted that “k” is an arbitrary coefficient, and “R” is a color deviation degree.

Herein, the color deviation degree “R” will be described. The computer 28 samples the color regarding n of points on a track on which the pointing device 20 moves, and calculates the color deviation degree “R” regarding n of the sampled colors. In a case that the color is uniform, and there is a small variation, a color friction resistance is small, and in a case that there is a color deviation, a color friction resistance becomes large. The color deviation degree “R” is calculated by applying an arbitrary weight to respective standard deviations of the hue, the saturation, and the luminance. More specifically, the color deviation degree “R” is calculated according to Equation 7.
R=stddev(H[n])·r1+stddev(S[n])·r2+stddev(V[n])·r3 [Equation 7]

It is noted that stddev(x) is a standard deviation, and r1, r2, and r3 are weighted coefficients. In addition, H[n] is a line of hues regarding the n of sampled points, S[n] is a line of saturations regarding the n of sampled points, and V[n] is a line of brightness regarding the n of sampled points. The value of the weighted coefficient can be set by a menu different from the color setting, for example. As recognized, the resistance values of the slide resistors 14a-14c are variable, and therefore, as a result of the user changing the resistance value, it becomes possible to modify a weight (importance) of each standard deviation.

The resultant force F formed of the inertia force Fi, the force of fluid resistance Ff, and the force of color friction resistance Fc thus calculated is added to the pointing device 20 (conductive material 20a) as described above. This resultant force F is calculated according to Equation 8.
F=w1·Fi+w2·Ff+w3·Fc [Equation 8]

It is noted that w1, w2, and w3 are weights, and are determinable in advance by using the slide resistors 14a-14c. That is, it is possible to set a weight by a menu different from the color setting, and to modify the weight (importance) of each force.

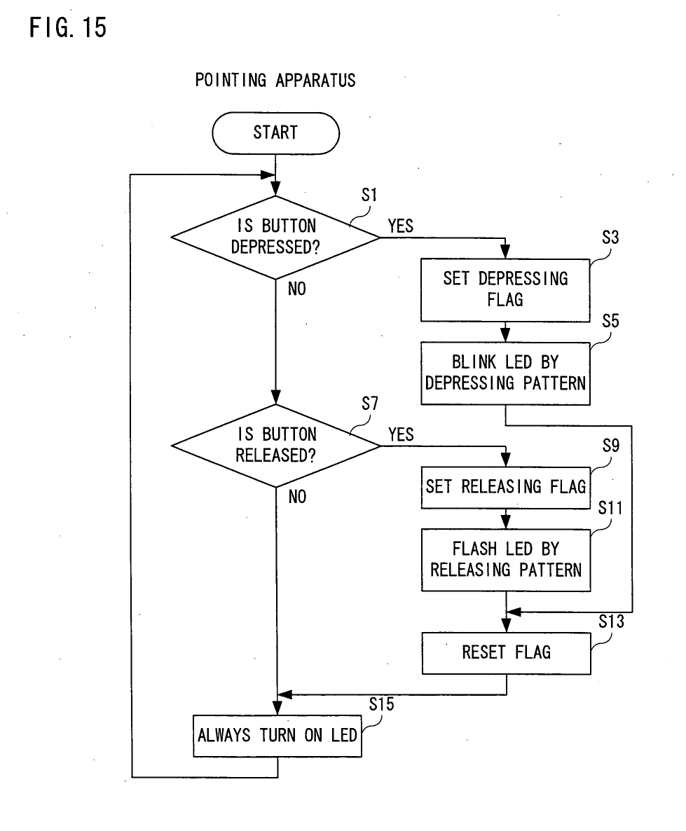

A specific description of the sensory drawing apparatus 10 will be made below by using a flowchart. FIG. 15 is a flowchart showing a process of the LED control circuit 20e provided in the pointing device 20. Referring to this FIG. 15, the LED control circuit 20e determines whether or not the button 20d is depressed in a step S1. If “NO” in the step S1, that is, unless the button 20d is depressed, the process directly advances to a step S7. On the other hand, if “YES” in the step S1, that is, if the button 20d is depressed, the depressing flag is set in a step S3, the infrared LED 20c is blinked according to a depressing pattern in a step S5, and the process advances to a step S13.

In the step S7, it is determined whether or not the button 20d is released. Herein, unless the button 20d is released, “NO” is determined in the step S7, and the process directly advances to a step S15. However, if the button 20d is released, “YES” is determined in the step S7, the releasing flag is set in a step S9, the infrared LED 20c is blinked according to the releasing pattern in a step S11. Then, the process advances to the step S13.

In the step S13, the depressing flag or the releasing flag is reset, and the process advances to the step S15. In the step S15, the infrared LED 20c is always turned on, and the process returns to the step S1.

Therefore, when the infrared LED 20c is always turned on, and there is an operation of the button 20d, it is possible to blink the infrared LED 20c according to the depressing pattern or the releasing pattern.

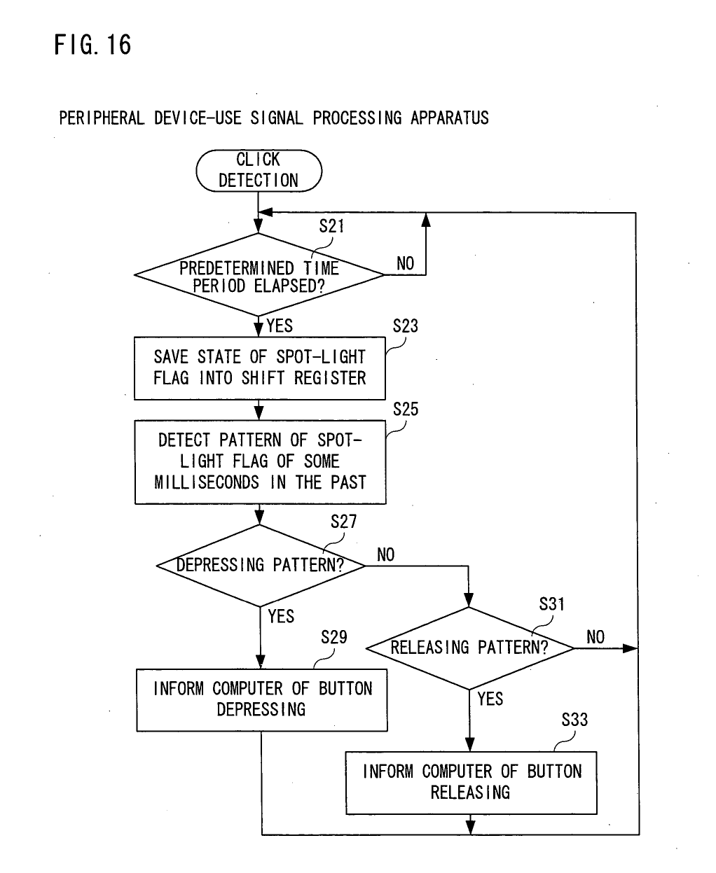

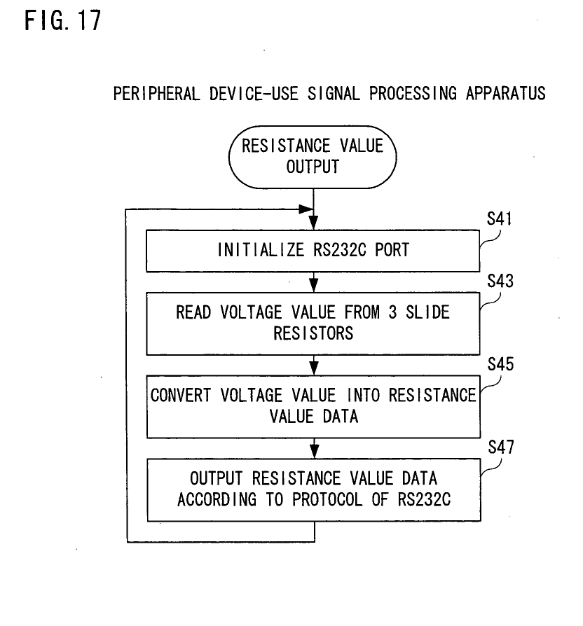

In FIG. 16, shown is a flowchart of a click detecting process, and in FIG. 17, shown is a flowchart of a resistance value outputting process. These processes are executed by the peripheral device-use signal processing apparatus 26 shown in FIG. 1. Referring to FIG. 16, when the click detecting process is started, it is determined whether or not a predetermined time period is elapsed in a step S21. This is to execute the detecting process of the click, that is, a depressing or releasing operation of the button 20d by an interruption by each predetermined time period.

It is noted that although omitted, the peripheral device-use signal processing apparatus 26 contains a timer inside, and counts the predetermined time period by this timer.

If “NO” in the step S21, that is, unless the predetermined time period is not elapsed, the process returns to the same step S21. On the other hand, if “YES” in the step S21, that is, if the predetermined time period is elapsed, a state (“1” or “0”) of the light-spot flag applied from the detection apparatus 24 is saved into a shift register (not shown) in a step S23.

In a succeeding step S25, referring to the shift register, the pattern of the light-spot flag of some milliseconds in the past is detected. As described later, the depressing pattern or the releasing pattern are made to be determined from the light-spot flag of some milliseconds in the past so that herein, detected is the light-spot flag regarding a time period (4-5 milliseconds) a little longer than a length (2-3 seconds) of these patterns. Therefore, the shift register has the number of bits that stores the state of the light spot flag regarding some milliseconds in the past. In addition, in a step S27, it is determined whether or not the depressing pattern. If the depressing pattern is herein determined, “YES” is determined in the step S27, the computer 28 is informed of the information on “button depression” in a step S29, and the process returns to the step Si. However, if the depressing pattern is not determined, “NO” is determined in the step S27, and it is determined whether or not the releasing pattern in a step S31.

If “NO” in the step S31, that is, unless the releasing pattern, the process directly returns to the step S21. On the other hand, if “YES” in the step S31, that is, if the releasing pattern, the computer 28 is informed of the information on “button depression” in the step S33, and the process returns to the step S21.

In addition, as shown in FIG. 17, when the peripheral device-use signal processing apparatus 26 starts the resistance value outputting process, the peripheral device-use signal processing apparatus 26 initializes a communication port (RS232C port, for example) in a step S41. In a succeeding step S43, the voltage values are read out from the three slide resistors 14a, 14b, and 14c. Next, in a step S45, the read voltage value is calculated into the resistance value, and further converted into the resistance value data. In a step S47, the resistance value data is output to the computer 28 according to a protocol of the RS232C, and the process returns to the step S41.

It is noted that in this embodiment, the above-described click detecting process and the resistance value outputting process are executed in parallel. However, the click detecting process and the resistance value outputting process are separate processes so that if there are provided a microchip and a DSP responsible for each process, it becomes possible to speed up the process.

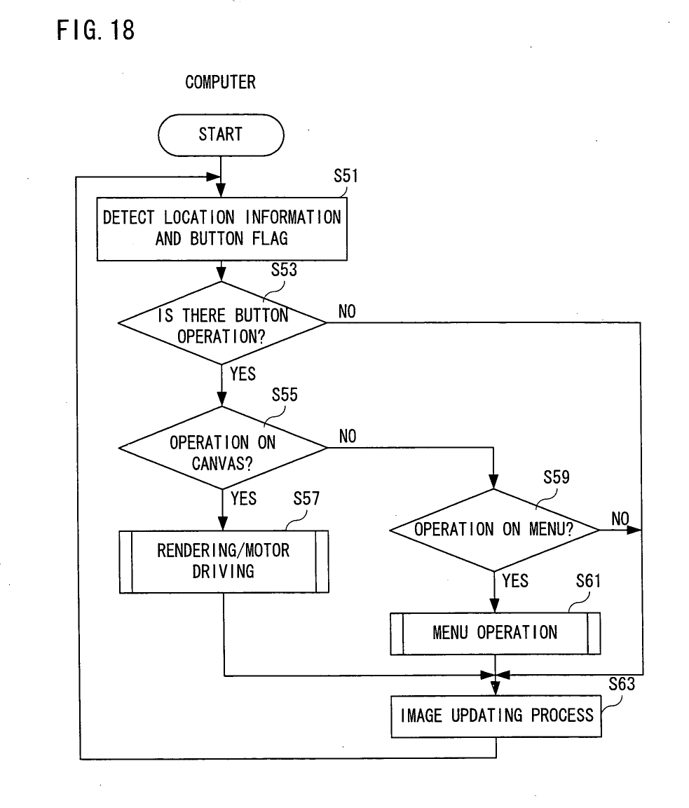

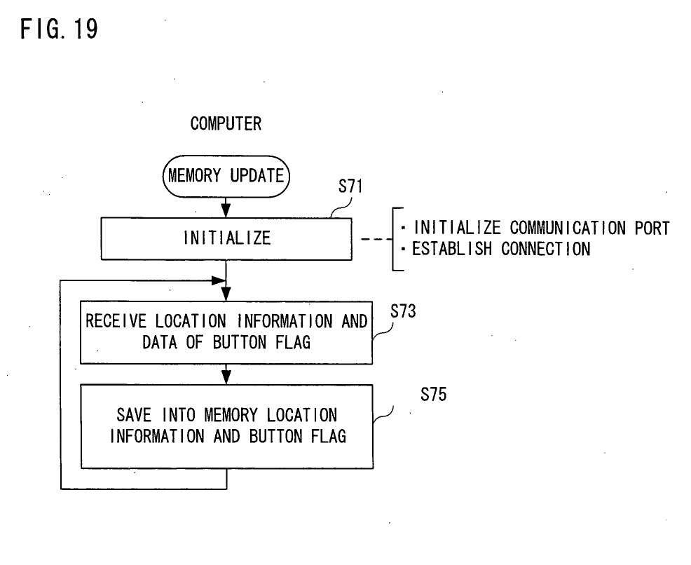

FIG. 18 is a flowchart showing a main process of the computer 28. When the computer 28 starts the process, the computer 28 detects the location information and the button flag by referring to the memory 28a in a step S51. By a memory updating process (FIG. 19) described later, the memory 28a is updated, and the latest location information and the button flag are always stored in the memory 28a. It is noted that the memory updating process is executed in parallel with the main process of the computer 28.

In a succeeding step S53, it is determines whether or not there is an operation of the button 20d. Herein, it is determined whether or not the button 20d is turned on by referring to the memory 28a. If “NO” in the step S53, that is, unless the button 20d is operated, the process directly advances to a step S63. On the other hand, if “YES” in the step S53, that is, if the button 20d is operated, it is determined whether or not the operation on the canvas, that is, on the image display area 102, in a step S55.

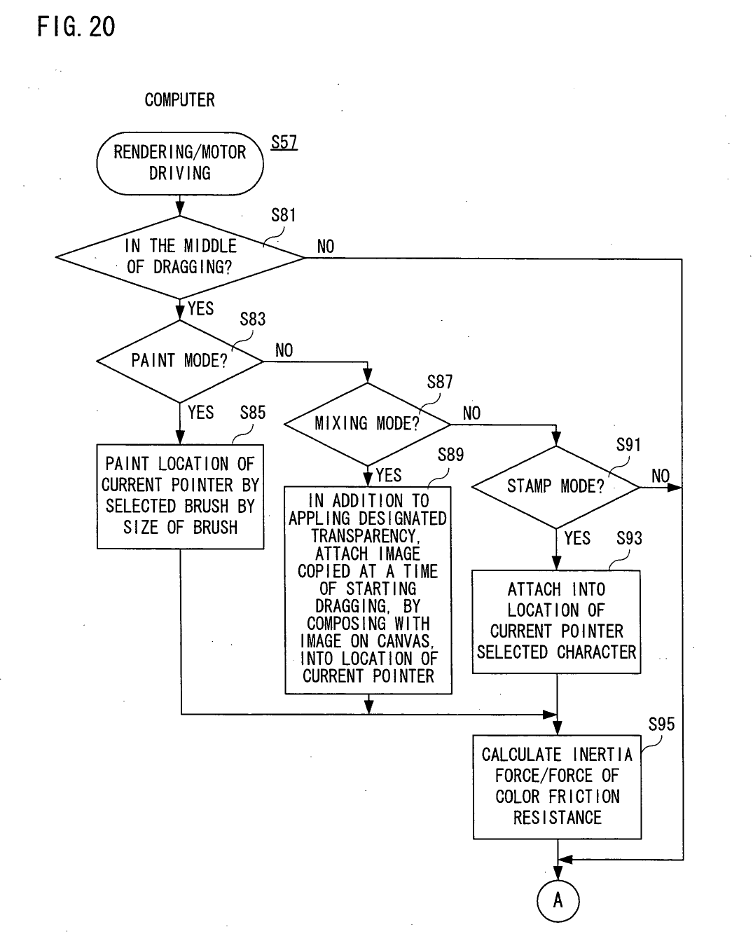

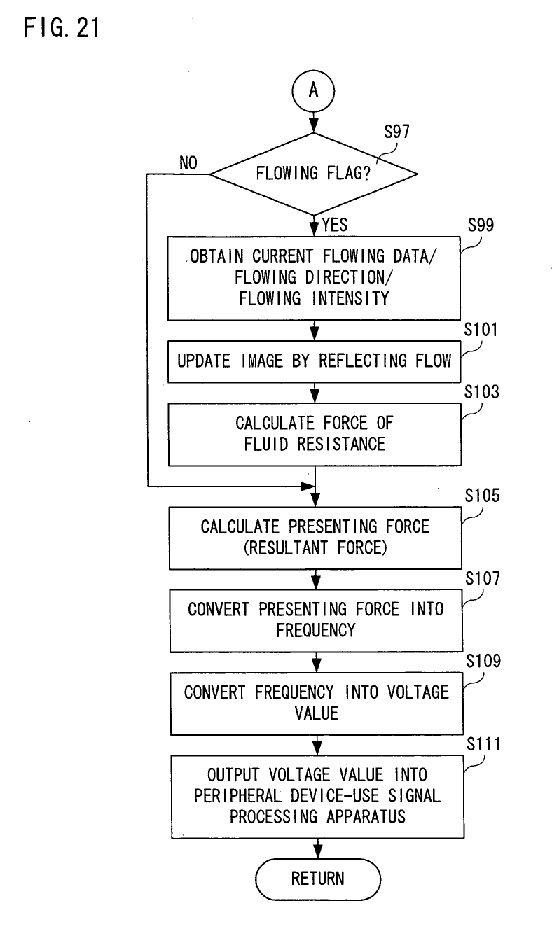

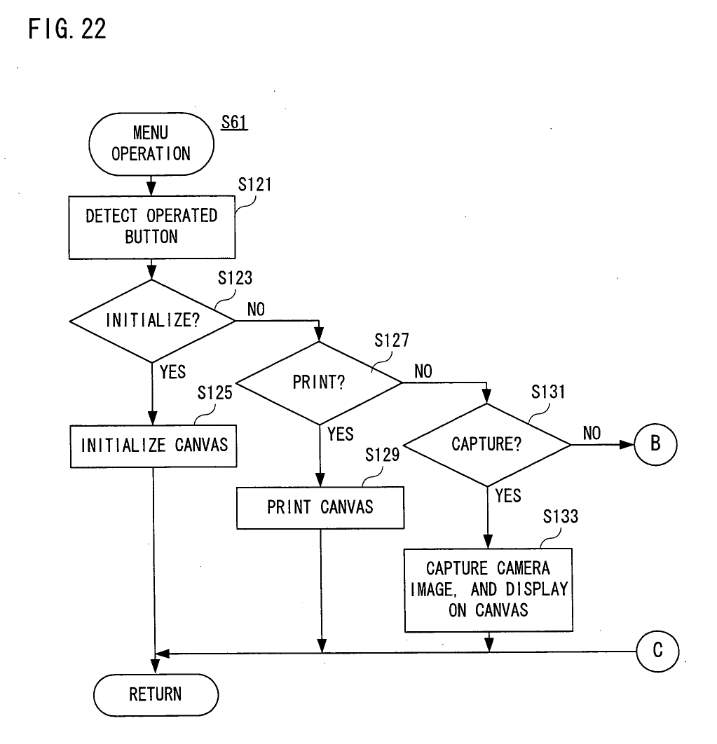

If “YES” in the step S55, that is, if the operation on the canvas, a motor driving process (see FIG. 20, FIG. 21) described later is executed in a step S57, and then, the process advances to the step S63. However, if “NO” in the step S55, that is, unless the operation on the canvas, it is determined whether or not the operation on the menu display area 104 in a step S59. Unless the operation on the menu display area 104, “NO” is determined in the step S59, and the process directly advances to the step S63. However, if the operation on the menu display area 104, “YES” is determined in the step S59, a menu operating process (see FIG. 22-FIG. 24) described later is executed in a succeeding step S61, and the process advances to the step S63.

In the step S63, the updating process of the image is executed, and the process returns to the step S51. Herein, the image drawn according to an operation of the user is updated, and the entire image is displayed in a flowing manner. It is noted that in a case that the flow flag is turned on, the entire image is displayed in a flowing manner. However, in a case that the flow flag is turned off, the image is not displayed in a flowing manner (still-displayed). In addition, in a case that the paint mode or the mixing mode is set, the icons for selecting the brushes are displayed in the icon display area 104i of the menu display area 104, and in a case that the stamp mode is set, the icons of the thumbnail images are displayed in the icon display area 104i.

FIG. 19 is a flowchart showing the above-described memory updating process. Referring to this FIG. 19, when the computer 28 starts the memory updating process, the computer 28 executes initializing the communication port and establishing a connection in a step S71. In a succeeding step S73, the computer 28 receives the location information, that is, the coordinates signal, and the data of the button flag. The button flag is set according to each of the “button depression” information or the “button releasing” information transmitted from the peripheral device-use signal processing apparatus 26. When it is informed of the “button depression” information, the depressing flag is set as the button flag, and when it is informed of the “button releasing”, the releasing flag is set as the button flag. In addition, in a step S75, the location information and the data of the button flag are saved (overwritten) in the memory 28a, and the process returns to the step S71.

FIG. 20 and FIG. 21 are flowcharts showing the rendering/motor driving process of the step S57 shown in FIG. 18. As shown in FIG. 20, when the rendering/motor driving process is started, it is determined whether or not in the middle of dragging in a step S81. More specifically, it is determined whether or not the depressing flag is turned on, and the location information is updated, referring to the memory 28a. If “NO” in the step S81, that is, unless in the middle of dragging, the process directly advances to a step S97 shown in FIG. 21. On the other hand, if “YES” in the step S81, that is, if in the middle of dragging, it is determined whether or not the paint mode is set in a step S83.

If “YES” in this step S83, that is, if the paint mode is set, the current location of the pointer 110 is painted by the selected color by the size of the brush, and the process advances to a step S95. However, the selected color is determined based on the resistance value data output from the peripheral device-use signal processing apparatus 26. Hereinafter, the same is true. In addition, herein, the selected color is only attached on the VRAM, and the display of the image is executed in the step S63 shown in the main process. Hereinafter, in the rendering/motor driving process, in a case of updating the image, it means that this is updated on the VRAM.

In addition, if “NO” in the step S83, that is, unless the paint mode is set, it is determined whether or not the mixing mode is set in a step S87. If “YES” in the step S87, that is, if the mixing mode is set, in a step S89, the computer 28 applies a designated transparency to the image copied at a time of starting dragging into the current location of the pointer 110, composes with the image of the canvas, attaches to the location, and then, advances to a step S95. On the other hand, if “NO” in the step S89, that is, unless the mixing mode is set, it is determined whether or not the stamp mode is set in a step S91.

If “NO” in the step S91, that is, unless the stamp mode is set, the process directly advances to a step S97 shown in FIG. 21. However, if “YES” in the step S91, that is, if the stamp mode is set, the computer 28 attaches the selected character to the location of the current pointer 110 in a step S93, and then, advances to the step S95.

In the step S95, each of the inertia force Fi and the force of color friction resistance Fc is calculated according to Equation 2 and Equation 3. However, unless the pointing device 20 transverses the color border, the force of color friction resistance Fc is 0 (zero). In addition, although omitted in the above-described description, in a case that the stamp mode is set, the inertia force Fi uses the value defined in advance in each character.

As shown in FIG. 21, in the succeeding step S97, it is determined whether or not the flow flag is turned on. If “NO” in the step S97, that is, if the flow flag is turned off, the process directly moves to the step S105. On the other hand, if “YES” in the step S97, that is, if the flow flag is turned on, the current flow data F(t) is obtained, and the flow direction (coefficient R) and the intensity of the flow (coefficient S) determined in the flow setting area 104h are obtained in a step S99. In a succeeding step S101, the image is updated by reflecting the flow. That is, each pixel is updated according to the corrected flow data F′(t) calculated according to Equation 1.

Subsequently, the force of fluid resistance Ff is calculated according to Equation 5 in a step S103. Next, in a step S105, the force (resultant force F) to present is calculated according to Equation 8. Thereafter, in a step S107, the calculated resultant force F is converted into the frequency, the frequency is converted into the voltage value in a step S109, the voltage value is output to the peripheral device-use signal processing apparatus 26 in a step S109, and the rendering/motor driving process is returned. It is noted that in response to the process of the step S109, the peripheral device-use signal processing apparatus 26 supplied the driving voltage to the inverters 18a and 18b.

Furthermore, FIG. 22-FIG. 24 are flowcharts regarding the menu operating process of the step S61 shown in FIG. 18. As shown in FIG. 22, when the computer 28 starts the menu operating process, the computer 28 detects the operated button in a step S121. That is, herein, referring to the memory 28a, the operated (clicked, dragged) button, and etc., are detected from the location information of the pointing device 20.

In a succeeding step S123, it is determined whether or not there is an instruction of an initializing button 104a, that is, it is determined whether or not the button 104a is clicked. If the button 104a is clicked, determining that there is the instruction of initializing, “YES” is determined in the step S123. The canvas, that is, the image display area 102, is initialized in a step S125, and the menu operating process is returned. However, in reality, the VRAM is initialized, and the updating of the image display is executed in the step S63 of the main process. However, unless the button 104a is clicked, determining that there is no instruction of initializing, “NO” is determined in the step S123. It is determined whether or not there is an instruction of printing in a step S127, that is, it is determined whether or not the button 104b is clicked.

If “YES” in the step S127, that is, if the button 104b is clicked, it is determined that there is the instruction of printing. The image displayed in the canvas, that is, the image display area 102, is printed using a printer not shown in a step S129, and the menu operating process is returned. On the other hand, if “NO” in the step S127, that is, unless the button 104b has not been clicked, it is determined that there is no instruction of printing. It is determined whether or not there is an instruction of capturing in a step S131, that is, it is determined whether or not the button 104c is clicked.

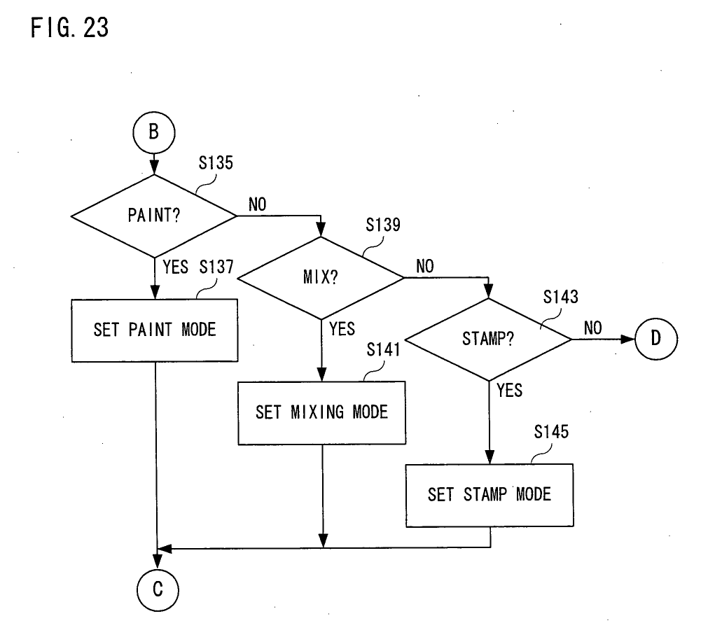

If “YES” in the step S131, that is, if the button 104c is clicked, it is determined that there is the instruction of capturing. The image (camera image) captured by a CCD camera not shown is captured, the image is displayed in the canvas, that is, the image display area 102 in a step S133, and the menu operating process is returned. However, in reality, the camera image is only attached to the VRAM, and the updating of the image display is executed in the step S63 of the main process. On the other hand, if “NO” in the step S131, that is, unless the button 104c is clicked, it is determined that there is no instruction of capturing. It is determined whether or not the paint mode is selected in a step S135 shown in FIG. 23, that is, it is determined whether or not the button 104d is clicked.

If “YES” in the step S135, that is, if the button 104d is clicked, the paint mode is set in a step S137, and the menu operating process is returned as shown in FIG. 23. On the other hand, if “NO” in the step S135, that is, unless the button 104d is clicked, it is determined whether or not the mixing mode is selected in a step S139, that is, it is determined whether or not the button 104e is clicked.

If “YES” in the step S139, that is, if the button 104e is clicked, the mixing mode is set in a step S141, and the menu operating process is returned. On the other hand, if “NO” in the step S139, that is, unless the button 104e is clicked, it is determined whether or not the stamp mode is selected in a step S143, that is, it is determined whether or not the button 104f is clicked.

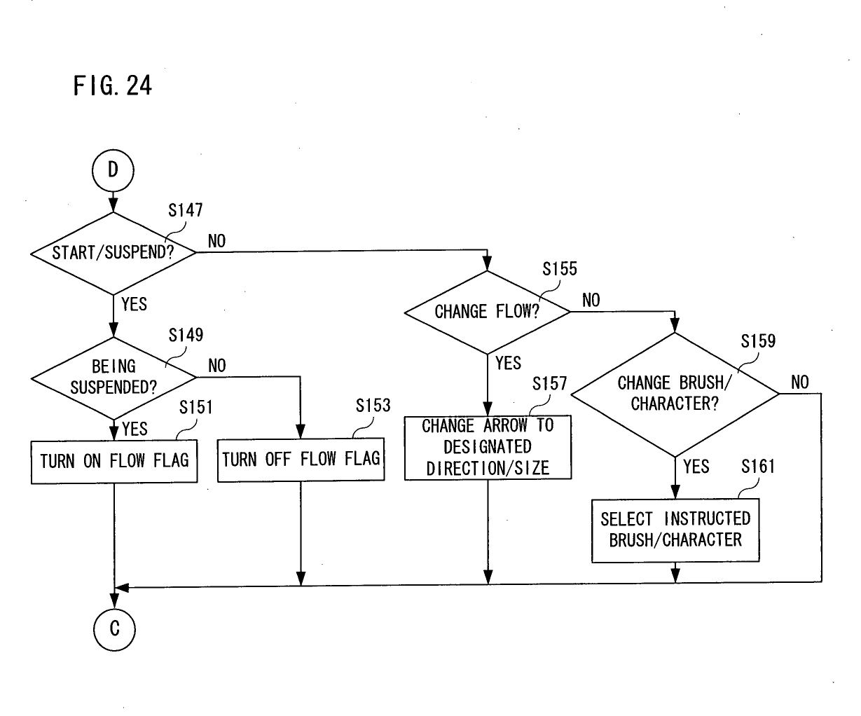

If “YES” in the step S143, that is, if the button 104f is clicked, the stamp mode is set in a step S145, and the menu operating process is returned. On the other hand, if “NO” in the step S143, that is, unless the button 104f is clicked, it is determined whether or not to instruct to start or to suspend the flow in a step S147 shown in FIG. 24, that is, it is determined whether or not the button 104g is clicked.

If “YES” in the step S147, that is, if the button 104g is clicked, it is determined whether or not the flow is being suspended in a step S149. That is, it is determined whether or not the flow flag is turned off. Herein, if the flow flag is turned off, “YES” is determined, and the flow flag is turned on in a step S151, and the menu operating process is returned as shown in FIG. 22. However, if the flow flag is turned on, “NO” is determined, and the flow flag is turned off in a step S153, and the menu operating process is returned.

On the other hand, if “NO” in the step S147, that is, unless the button 104g is clicked, it is determined that not instruct to start or suspend the flow. Then, it is determined whether or not to instruct to change (or set) the flow in a step S155, that is, it is determined whether or not the arrow 104h′ of the flow setting area 104h is dragged.

If “YES” in the step S155, that is, if the arrow 104h′ is dragged, the arrow 104h′ is changed to a designated (instructed) direction and size in a step S157, and the menu operating process is returned. Thereby, the direction and the intensity of the flow is changed (set). On the other hand, if “NO” in the step S155, that is, unless the arrow 104h′ is dragged, it is determined whether or not to instruct to change (or set) the brush or the character in a step S159. That is, it is determined whether or not the icon displayed in the icon display area 104i is clicked (selected).

If “NO” in the step S159, that is, in a case that any button or icon on the menu display area 104 is not clicked nor dragged, the menu operating process is directly returned. On the other hand, if “YES” in the step S159, that is, any one of the icons displayed in the icon display area 104i is clicked, the brush or the character that corresponds to the clicked icon is selected in a step S161, and the menu operating process is returned. In the step S161, the flag regarding the selected brush or character is turned on, which makes it obvious to determine that it is being selected, for example.

According to this embodiment, the force corresponding to the color of the image or the flow of the image at a time that the user draws is to be added so that it is not only possible to obtain a sense of immersion as if to draw a picture on an actual canvas, but also to draw by enjoying a virtual touch of the image obtainable from the weight defined to the color, and a sensation resulted from phenomenon by the flow of the image that resembles a flow of water. That is, it is possible to provide a computer interface with greater ease to use.

It is noted that in this embodiment, in order to detect the location of the pointing device, a detection element that detects infrared light, and etc., are used. However, it is also possible to detect the location by processing and analyzing the image captured by a camera that uses a CCD imager and a CMOS. In such the case, the button click information needs to input into the computer in a wireless or wired manner.

In a case that the luminance is high, the weight of color is rendered light, and in a case that the luminance is low, the weight of color is rendered heavy in this embodiment. However, in a case that the luminance is high, the weight of color is rendered heavy, and in a case that the luminance is low, the weight of the color is rendered light.

In addition, in this embodiment, in order to present the force to the user, the linear motor is used, and its conductor material is made to be provided in one portion of the pointing device held by the user. However, the apparatus that present the force to the user is not limited thereto.

A “Phantom®: product name” manufactured by US SensAble Technologies may be used, for example. In this case, in place of the linear motor, the pointing device, and the detection apparatus shown in the above-described embodiment, the “Phantom” may be applicable. That is, the presenting of the operation information of the user, the operation location, and the force are performed by using the “Phantom”. This “Phantom” is introduced in a homepage of SensAble Technologies (URL http://www.sensable.com/products/phantom_ghost/phantom.asp).

In addition, a “SPIDAR-G: product name” manufactured by Cyverse Corporation, too, is usable. That is, similar to the above-described “Phantom”, in place of the linear motor, the pointing device, and the detection apparatus shown in the above-described embodiment, if the “SPIDAR-G” is applicable, it is possible to present the force to the user though this “SPIDAR-G”. This “SPIDAR-G” is introduced in a homepage of Cyverse Corporation (URL http://www.cyverse.co.jp/jp/Products/3dGrip).

I Furthermore, in a case of replacing to such the force presenting apparatus, in place of being limited to structure in which the video or the image output from the projector is displayed on the desk plate, an LCD, an EL panel, or a CRT, and etc., may be used.

Although the present invention has been described and illustrated in detail, it is clearly understood that the same is by way of illustration and example only and is not to be taken by way of limitation, the spirit and scope of the present invention being limited only by the terms of the appended claims.

1. A sensory drawing apparatus, comprising:
a displaying means for displaying at least an image;
a pointing means for inputting at least operation information by a user so as to draw; and
a force presenting means for applying a force at least corresponding to a color of a drawn image to said pointing means when drawn by said pointing means.

2. A sensory drawing apparatus according to the claim 1, further comprising
a color determining means for determining at least the color, wherein
said displaying means includes a color attaching means for attaching the color determined by said color determining means into a current location instructed by said pointing means when drawn by said pointing means.

3. A sensory drawing apparatus according to the claim 1, wherein
said displaying means includes a mixing means for applying a predetermined transparency, and mixing the color displayed in a location currently instructed by said pointing means to the color attached in the location instructed by said pointing means at a time of starting an operation when drawn by said pointing means.

4. A sensory drawing apparatus according to the claim 1, wherein
said displaying means displays said image in a flowing manner to an arbitrary direction.

5. A sensory drawing apparatus according to the claim 4, further comprising
a flow determining means for determining at least the direction to which said image flows, wherein
said displaying means displays said image in a flowing manner to the direction determined by said flow determining means.

6. A sensory drawing apparatus according to the claim 5, wherein
said flow determining means further determines a force of flow of said image.

7. A sensory drawing apparatus according to the claim 4, wherein
said force presenting means applies to said pointing means a force based on at least one of inertia force by a weight of color corresponding to an attached color, a force of flow resistance by a flow of said image, and a force of color change resistance in a color border regarding an image already drawn.

8. A sensory drawing apparatus according to the claim 7, wherein
said weight of color is determined according to any one or more than one of luminance, brightness, hue and saturation of color, or a combination thereof.

9. A sensory drawing apparatus according to the claim, 1, wherein
said displaying means includes at least a desk plate and a projector,
said pointing means includes a holding portion to be held by a user and an operation information detecting means that detects said operation information, and
said force presenting means includes a linear induction motor provided with a conductivity material joined to said holding portion and provided on said desk plate, a stator core provided under said desk plate, and a stator coil wound around said stator core.
